(19) United States
(12) Patent Application Publication
(10) Pub. No.: US 2009/0281808 A1
(43) Pub. Date: Nov. 12, 2009

(54) VOICE DATA CREATION SYSTEM, PROGRAM, SEMICONDUCTOR INTEGRATED CIRCUIT DEVICE, AND METHOD FOR PRODUCING SEMICONDUCTOR INTEGRATED CIRCUIT DEVICE

(75) Inventors: Jun NAKAMURA, Hachiouji-shi (JP); Fumihito BAISHO, Tachikawa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/431,369

(22) Filed: Apr. 28, 2009

(30) Foreign Application Priority Data
May 7, 2008 (JP) 2008-121523
Feb. 27, 2009 (JP) 2009-046338

(51) Int. Cl. G10L 13/04

(52) U.S. Cl. 704/258; 704/E13.005

(57) ABSTRACT

A voice data creation system includes a dictionary data memory section that stores dictionary data for generating synthesized voice data corresponding to text data; an edition processing section that displays an edition screen for editing a voice guidance message as a sentence including a plurality of phrases to receive edition input formation so as to perform an edition processing based on the edition input information; a list information generation processing section that generates list information relating to each sentence and phrases included in the each sentence based on a result of the edition processing; a phrase voice data generating section that determines a target phrase for voice data creation based on the list information to generate and maintain voice data corresponding to the target phrase determined for voice data creation based on the dictionary data; and a memory write information generating section that determines a target phrase to be stored in a voice data memory based on the list information to generate memory write information including voice data of the target phrase determined to be stored in the memory. In the system, the edition processing section divides a sentence input on the edition screen into a plurality of phrases based on text data of the sentence input; the list information generation processing section specifies the phrases included in the sentence and a reproduction order of the phrases based on a result of the sentence division to generate sentence information including phrase specification information of the phrases included in the sentence and sequence information relating to the reproduction order of the phrases; the phrase voice data generating section generates synthesized voice data corresponding to text data of the target phrase for voice data creation based on the dictionary data; and the memory write information generating section determines the target phrase to be stored in the memory such that voice data of a phrase used commonly in a plurality of sentences and a phrase used a plurality of number of times in a single sentence are not duplicately stored.

The entire disclosure of Japanese Patent Application No. 2008-121523, filed May 7, 2008 and Japanese Patent Application No. 2009-46338, filed Feb. 27, 2009 are expressly incorporated by reference herein.

### BACKGROUND

1. Technical Field

An aspect of the present invention relates to a voice data creation system, a programs a semiconductor integrated circuit device, and a method for producing the semiconductor integrated circuit device.

2. Related Art

There are known electronic apparatuses including a voice reproduction system with a host processor and a voice integrated circuit (IC). In the system, the host processor and the voice IC work together to allow voice messages to be output.

JP-A-2002-023781 is an example of the related art.

In an electronic apparatus or the like having a voice function to output voice guidance messages preset as a user interface, there is provided a voice reproduction system. In the voice reproduction system, a voice data file corresponding to a voice guidance message intended to be output is stored in a built-in ROM of a voice reproduction device (a voice guidance IC). Then, in response to a command from a host processor, voice data read from the built-in ROM is reproduced and output.

In the conventional voice data creation system using the voice guidance IC, when a single text is input, a voice synthesis processing creates a single voice file corresponding to the single text. Accordingly, in order to create a plurality of voice message data, it is necessary to repeat steps “from text input to voice file creation” by a number of messages to be created. Additionally, only the single voice file can be created. Thus, when creating a ROM image file to be stored in the built-in ROM of the voice guidance IC and an external RAM, a plurality of voice message data to be stored in the ROM need to be all created before creating ROM image files. Consequently, it is difficult to perform steps of “text input, voice data creation, and then ROM-image file creation”.

In addition, when a plurality of voice guidance messages are intended to output, it is desirable to completely and surely store voice files sufficient to reproduce the voice guidance messages.

### SUMMARY

The present invention has been accomplished in light of the above technological problems. An advantage of the present invention is to provide a voice data creation system that efficiently creates voice files sufficient to reproduce a plurality of voice guidance messages by automating a process from a step of editing voice guidance message to be output to a step of creating memory write information (a ROM image file) in an electronic apparatus or the like. Other advantages of the invention are to provide a program allowing a computer to execute the voice data creation system, a semiconductor integrated circuit device with the system, and a method for producing the semiconductor integrated circuit device with the system.

A voice data creation system according to a first aspect of the invention includes a dictionary data memory section that stores dictionary data for generating synthesized voice data corresponding to text data; an edition processing section that displays an edition screen for editing a voice guidance message as a sentence including a plurality of phrases to receive edition input formation so as to perform an edition processing based on the edition input information; a list information generation processing section that generates list information relating to each sentence and phrases included in the each sentence based on a result of the edition processing; a phrase voice data generating section that determines a target phrase for voice data creation based on the list information to generate and maintain voice data corresponding to the target phrase determined for voice data creation based on the dictionary data; and a memory write information generating section that determines a target phrase to be stored in a voice data memory based on the list information to generate memory write information including voice data of the target phrase determined to be stored in the memory. In the system, the edition processing section divides a sentence input on the edition screen into a plurality of phrases based on text data of the sentence input; the list information generation processing section specifies the phrases included in the sentence and a reproduction order of the phrases based on a result of the sentence division to generate sentence information including phrase specification information of the phrases included in the sentence and sequence information relating to the reproduction order of the phrases; the phrase voice data generating section generates synthesized voice data corresponding to text data of the target phrase for voice data creation based on the dictionary data; and the memory write information generating section determines the target phrase to be stored in the memory such that voice data of a phrase used commonly in a plurality of sentences and a phrase used a plurality of number of times in a single sentence are not duplicately stored.

For example, each of the phrases is a clause or a part of a sentence. Each sentence may be a group of words provided as a voice guidance message in an electronic apparatus or the like. The text data may be data of characters (codes representing alphabets or kana and kanji characters, and numbers), and may be represented by ASCII codes or JIS codes.

For example, the phrase voice data generating section generates voice data corresponding to phrase text data by using a text-to-voice (TTS) mode, which may be provided by an existing TTS tool.

The phrase specification information may be data allowing access to file information of the voice data corresponding to the phrases and may be an a phrase data ID or a phrase data index, where it is only necessary to store a name of a phrase voice data file in association with the phrase data ID or the phrase data index.

The sentence information may be formed by arranging the phrase specification information of the phrases included in a sentence (or the file information (file name) of the phrase voice data) in accordance with the sequence information and may be stored in association with a sentence ID.

The list information may include phrase data such as the file information of phrase voice data (e.g. a file name), a phrase reproduction time, and a size data of the phrase voice data file in association with the phrase specification information.

The phrase voice data generating section may compress generated voice data into a data file per phrase to maintain the data file per phrase.

For example, when the list information includes use frequency data of phrases used in sentences and data indicating a presence or absence of writing of the phrases in the memory (ROM), phrases used one or more times and phrases that the data indicate are written in the memory (ROM) may be determined as target phrases to be stored.

In the voice data creation system of the first aspect, the presence or absence of writing of each phrase in the memory (ROM) is determined based on the list information. Thus, also regarding phrases used in a plurality of sentences, memory write information (a ROM image) can be generated in such a manner that same voice data are not duplicately stored in the memory. Accordingly, also regarding phrases shared between or among the sentences and phrases a plurality of number of times used in a signal sentence, voice data of the respective phrases are stored only one time, thereby enabling an increase in a memory size to be prevented.

For example, the list information generation processing section may count frequencies of the phrases used in common among the sentences or a frequency of a phrase used a plurality of number of times in a single sentence to maintain count values as phrase data. In terms of a predetermined phrase, there may be prepared a plurality of voice data files having different sound qualities (voice data files having different file sizes) to use a voice data file having a different sound quality in accordance with the count value of a phrase use frequency. For example, for a frequently used phrase, a good quality voice data file may be used to efficiently improve sound quality.

In the system of the first aspect, a single tool performs a process from edition of a plurality of text data to be used as a plurality of voice guidance messages to creation of the memory write information (ROM image files). This allows voice files necessary and sufficient to reproduce the voice guidance messages to be generated automatically and efficiently.

Preferably, in the voice data creation system of the first aspect, the text data of the sentence includes pause data indicating a phrase pause, and the edition processing section performs the sentence dividing processing based on the pause data.

For example, the pause data may be space character or text data using a predetermined character or symbol.

Here is an example of a sentence: “Please turn off the power.” When there is a phrase datum including phrases among which words are partially common, such as “the power”, “turn off the power”, “Please turn off”, and “Please”, intended phrases can be formed by designating desired pausing positions by using each space so as to present the sentence as “Please turn off the power”.

Preferably, in the system of the first aspect, the memory write information generating section calculates a total size of the memory write information to output size information based on a result of the calculation.

When creating voice data corresponding to phrases, the phrase voice data generating section may generate file size information of the voice data to maintain the file size information in association with a voice data file and phrase specification information, and the memory write information generating section may calculate the total size of the memory write information based on the file size information of the voice data of a target phrase to be stored.

In addition, memory size information for use and the total size may be compared with each other to output a comparison result. When the memory size information for use is found to be smaller than the total size, warning information may be output.

Preferably, in the system of the first aspect, the edition processing section performs a display output processing for displaying the phrases included in the sentence.

This allows confirmation of the sentence and the phrases included in the sentence.

Preferably, in the system of the first aspect, the edition processing section combines a plurality of phrases to create a sentence based on the edition input information, and the list information generation processing section specifies the phrases included in the sentence and a reproduction order of the phrases based on a result of the phrase combination to generate sentence information including phrase specification information of the phrases included in the sentence and sequence information relating to the reproduction order of the phrases.

Preferably, in the system of the first aspect, the edition processing section generates and maintains reading information indicating a way to read (pronounce) the sentence or the phrases to display and output the reading (pronunciation) of the sentence or the phrases based on the maintained reading information.

In this case, preferably, the edition processing section receives reading input information relating to the reading information of the sentence or the phrases to update the maintained reading information based on the received reading input information.

Preferably, the system of the first aspect further includes a voice reproduction output processing section that determines the phrases included in the sentence and the reproduction order of the phrases based on the sentence information to reproduce and output voice data of the phrases in accordance with the reproduction order.

The voice data maintained in association with the phrase specification information may be read to be reproduced and output in accordance with the sequence information.

Preferably, the system of the first aspect, the edition processing section receives edition input of waiting time information regarding a length of a soundless interval set in at least one of positions before and between the phrases included in the sentence, and the list information generation processing section generates the sentence information that further includes the waiting time information.

The sentence information may be data formed by associating each sentence with each ID and arranging the phrase specification information of the phrases included in the each sentence or the file information (the file name) of voice data of the phrases and the waiting time information set before or between the phrases in accordance with the reproduction order (the sequence information).

Preferably, in the system above, the voice reproduction output processing section sets the soundless interval before or between the phrases based on the waiting time information to reproduce and output sound of the voice data.

Preferably, the system of the first aspect further includes a voice reproduction command generating section that generates a sentence voice reproduction command, the command providing an instruction for reading out voice data necessary to reproduce voice of the sentence from the voice data memory to reproduce the voice data in accordance with the reproduction order of the phrases included in the sentence based on the sentence information.

According to a second aspect of the invention, there is provided a program allowing a computer to operate as a voice data creation system. The system includes a dictionary data memory section that stores dictionary data for generating synthesized voice data corresponding to text data; an edition processing section that displays an edition screen for editing a voice guidance message as a sentence including a plurality of phrases to receive edition input formation so as to perform an edition processing based on the edition input information; a list information generation processing section that generates list information relating to each sentence and phrases included in the each sentence based on a result of the edition processing; a phrase voice data generating section that determines a target phrase for voice data creation based on the list information to generate and maintain voice data corresponding to the target phrase determined for voice data creation based on the dictionary data; and a memory write information generating section that determines a target phrase to be stored in a voice data memory based on the list information to generate memory write information including voice data of the target phrase determined to be stored in the memory. In the system, the edition processing section divides a sentence input on the edition screen into a plurality of phrases based on text data of the sentence input; the list information generation processing section specifies the phrases included in the sentence and a reproduction order of the phrases based on a result of the sentence division to generate sentence information including phrase specification information of the phrases included in the sentence and sequence information relating to the reproduction order of the phrases; the phrase voice data generating section generates synthesized voice data corresponding to text data of the target phrase for voice data creation based on the dictionary data; and the memory write information generating section determines the target phrase to be stored in the memory such that voice data of a phrase used commonly in a plurality of sentences and a phrase used a plurality of number of times in a single sentence are not duplicately stored.

According to a third aspect of the invention, there is provided a method for producing a voice synthesis semiconductor integrated circuit device including a nonvolatile memory section. The method includes preparing a dictionary data memory section that stores dictionary data for generating synthesized voice data corresponding to text data; displaying an edition screen for editing a voice guidance message as a sentence including a plurality of phrases to receive edition input information to perform an edition processing based on the edition input information; generating list information relating to each sentence and phrases included in the each sentence based on a result of the edition processing; determining a target phrase for voice data creation based on the list information to generate and maintain voice data corresponding to the target phrase determined for voice data creation based on the dictionary data; and determining a target phrase to be stored in the nonvolatile memory section based on the list information to generate memory write information including voice data of the target phrase determined to be stored in the memory. In the method, the edition processing divides a sentence input on the edition screen into a plurality of phrases based on text data of the sentence input; the list information generation processing specifies the phrases included in the sentence and a reproduction order of the phrases based on a result of the sentence division to generate sentence information including phrase specification information of the phrases included in the sentence and sequence information relating to the reproduction order of the phrases; the phrase voice data generation processing generates synthesized voice data corresponding to text data of the target phrase for voice data creation based on the dictionary data; and the memory write information generation processing determines the target phrase to be stored in the memory such that voice data of a phrase used commonly in a plurality of sentences or a phrase used a plurality of number of times in a single sentence are not duplicately stored.

According to a fourth aspect of the invention, there is provided a semiconductor integrated circuit device including a nonvolatile memory section storing the memory write information generated by the voice data creation system of the first aspect and a voice synthesizing section receiving a voice reproduction command to read out the voice data included in the memory write information from the nonvolatile memory section so as to reproduce and output the voice data based on the received voice reproduction command.

For example, the semiconductor integrated circuit device of the fourth aspect is a voice IC incorporated in an electronic apparatus or the like and works together with a host processor (also incorporated in the electronic apparatus) to allow voice messages to be output. The semiconductor integrated circuit device may receive the voice reproduction command from the host processor.

### BRIEF DESCRIPTION OF THE DRAWINGS

The invention will be described with reference to the accompanying drawings, wherein like numbers reference like elements.

FIG. 1 is an example of a functional block diagram of a voice data creation system according to an embodiment of the invention.

FIG. 2 is a diagram illustrating voice data of a phrase and phrase information (phrase data and phrase edition information).

FIG. 3 is a diagram illustrating sentence information.

FIG. 4A is a diagram illustrating a process for generating memory write information (a ROM image).

FIG. 4B is a diagram illustrating a use form of the memory write information (the ROM image).

FIG. 5 is a flowchart showing steps from edition of a sentence to creation of a ROM file.

FIG. 6 is a diagram showing an example of a sentence edition screen.

FIG. 7 is a diagram showing an example of an input sentence.

FIG. 8 is a diagram showing an example of a phrase edition screen.

FIG. 9 is a diagram showing an example of a sentence/phrase correlation confirmation screen.

FIG. 10 is a diagram showing an example of a ROM-file creation screen.

FIG. 11 is a diagram illustrating processings performed by a voice data creation tool.

FIGS. 12A and 12B are diagrams illustrating examples of the processings by the voice data creation tool.

### DESCRIPTION OF EXEMPLARY EMBODIMENTS

Embodiments of the invention will be described in detail with reference to the drawings. The embodiments described below do not restrict the scope of the invention defined by appended claims. In addition, not all of structures explained below are essential constituent elements of the invention.

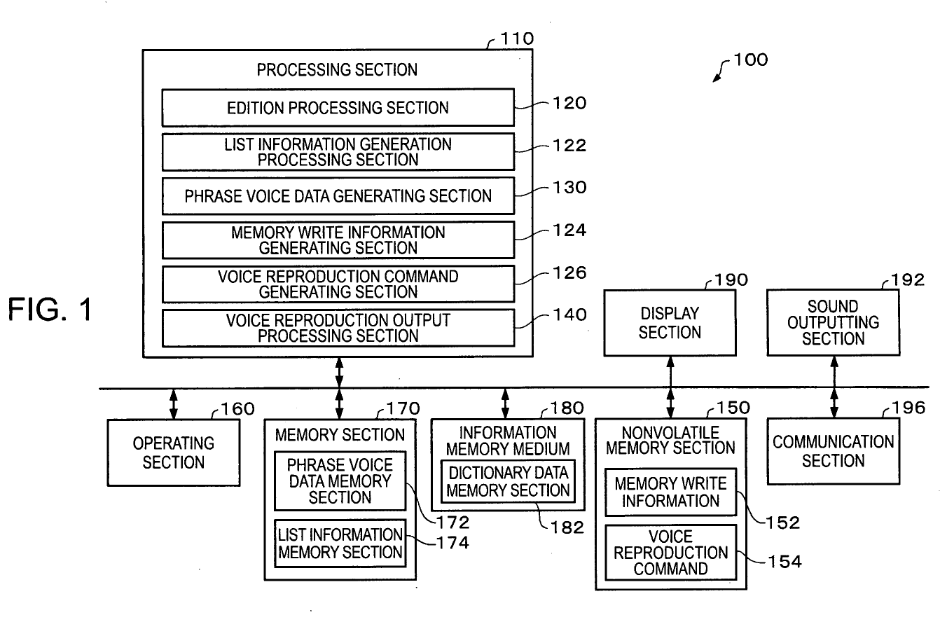

FIG. 1 is an example of a functional block diagram of a voice data creation system according to an embodiment of the invention. A voice data creation system 100 of the embodiment does not necessarily include all of constituent elements (sections) in FIG. 1 and may exclude a part of the elements.

An operating section 160 is used to input a user's operation or the like as data and may be hardware such as an operation button, an operation lever, a touch panel, a microphone, or the like.

A memory section 170 is a work region for a processing section 110, a communication section 196, or the like and may be hardware such as a RAM.

The memory section 170 may serve as a phrase voice data memory section 172 maintaining (storing) created phrase voice data.

Alternatively, the memory section 170 may serve as a list information memory section maintaining (storing) list information relating to each sentence and phrases included in the each sentence. An information memory medium 180 (a computer-readable medium) stores a program, data, and the like. The information memory medium 180 may be hardware such as an optical disk (such as a CD, a DVD, or the like), an optical magnetic disk (MO), a magnetic disk, a hard disk, a magnetic tape, or a memory (a ROM).

The information memory medium 180 may also store a program for allowing a computer to operate as each section in the system of the present embodiment and auxiliary data (additional data). For example, the information memory medium 180 may serve as a dictionary data memory section (a TTS voice synthesis dictionary) 182 storing dictionary data for generating synthesized voice data corresponding to text data.

The processing section 110 performs various processings of the embodiment based on such a program (data) stored in the information memory medium 180 or such data or the like read from the information memory medium 180. Accordingly, the information memory medium 180 stores a program for allowing the computer to execute processings of respective sections in the system of the embodiment.

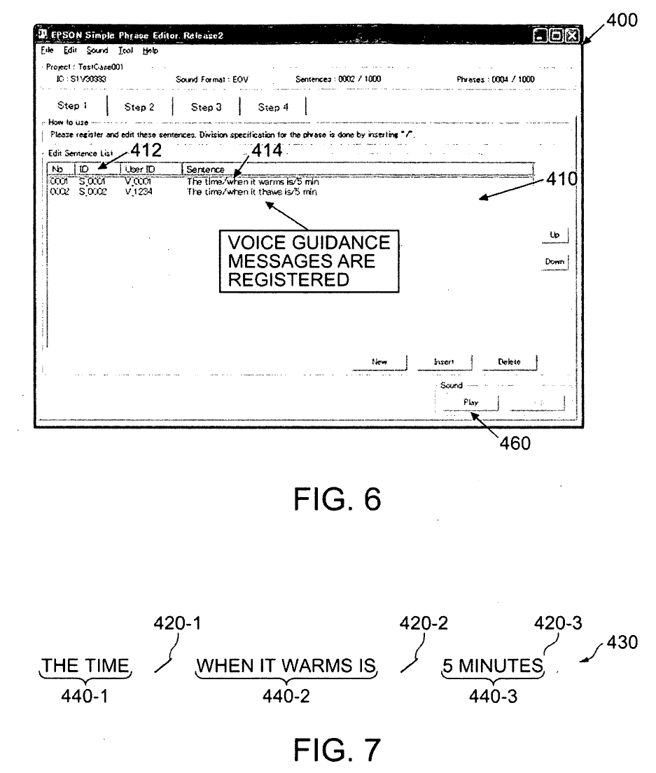

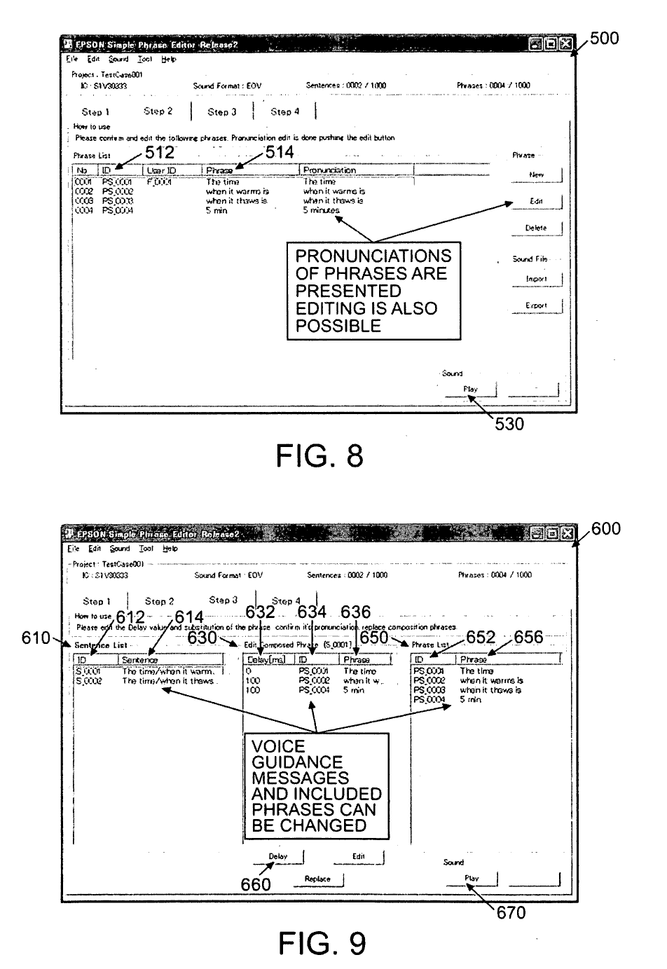

A display section 190 outputs an image generated by the system of the embodiment and may be hardware such as a CRT display, a liquid crystal display (LCD), an organic electro-luminescence display (OELD), a plasma display panel (PDP), or a touch panel display. The display section 190 displays edition screens of the system of the embodiment (as in FIG. 6, and FIGS. 8 to 19), and the like.

A sound outputting section 192 outputs a synthesized voice or the like generated by the system of the embodiment and may be hardware such as a speaker or a headphone.

A communication section 196 performs various controls for communicating with an external device (e.g. a host device or another terminal device) and may be hardware such as any of various kinds of processors or a communication application-specific integrated circuit (ASIC), a program, or the like.

The program (data) for operating the computer as each section of the embodiment may be distributed to the information memory medium 180 (or the memory section 170) via a network and the communication section 196 from a data memory medium included in the host device (a server device). Use of the data memory medium of the host device (such as the server device) can be included in the scope of the embodiment.

A nonvolatile memory section 150 is formed of a memory medium serving as a nonvolatile memory and may be a ROM used as a built-in ROM of a voice synthesis IC incorporated in an electronic apparatus. Memory write information 152 and a voice reproduction command 154 may be written in the nonvolatile memory section 150.

The processing section 110 (processor) performs various processings using the memory section 170 as a work region. The processing section 110 may be hardware such as any of various processors including a central processing unit (CPU) and a digital signal processor (DSP) or an ASIC (e.g. a gate array), or may be operated by a program.

The processing section 110 may include an edition processing section 120, a list information generation processing section 122, a memory write information generating section 124, a voice reproduction command generating section 126, a phrase voice data generating section 130, and a voice reproduction output processing section 140.

The edition processing section 120 displays an edition screen of a voice guidance message as a sentence including a plurality of phrases to receive edition input information so as to perform an editing processing based on the edition input information received. The list information generation processing section 122 generates list information relating to each sentence and phrases included in the each sentence based on a result of the edition processing. The phrase voice data generating section 130 determines a target phrase for voice data creation based on the list information to generate and maintain voice data corresponding to the target phrase for voice data creation based on the dictionary data. Based on the list information, the memory write information generating section 124 determines a target phrase to be stored in a voice data memory to maintain voice data of the target phrase determined to be stored in the memory. Based on text data of a sentence input on the edition screen, the edition processing section 120 divides the sentence into a plurality of phrases. Based on a result of the sentence division, the list information generation processing section 122 specifies phrases included in the sentence and a reproduction order of the phrases to generate sentence information including phrase specification information of the phrases included in the sentence and sequence information relating to the phrase reproduction order. The phrase voice data generating section 130 generates synthesized voice data corresponding to text data of the target phrase for voice data creation based on the dictionary data. Regarding a phrase used commonly in a plurality of sentences and a phrase used a plurality of number of times in a single sentence, the memory write information generating section 124 determines the target phrase to be stored in the memory such that voice data of the repeatedly used phrases are not duplicately stored.

The text data of the sentence may include pause data indicating a phrase pause, and the edition processing section 120 may perform the sentence dividing processing based on the pause data.

The memory write information generating section 124 may calculate a total size of the memory write information to output size data based on a result of the calculation.

The edition processing section 120 may perform a display outputting processing for displaying the phrases included in the sentence.

In addition, based on edition input information, the edition processing section 120 may combine a plurality of phrases to create each sentence. Based on a result of the phrase combination, the list information generation processing section 122 may specify phrases included in the each sentence and a reproduction order of the phrases to generate sentence information including phrase specification information of the phrases included in the sentence and sequence information relating to the phrase reproduction order.

Furthermore, the edition processing section 120 may generate and maintain reading information phonetically indicating how to read (pronounce) the sentence or the phrases to display and output the reading (pronunciation) of the sentence or the phrases based on the maintained reading information.

In addition, the edition processing section 120 may receive reading input information regarding the reading (pronunciation) information of the sentence or the phrases to update the maintained reading information based on the received reading input information.

The voice reproduction output processing section 140 determines the phrases included in the sentence and the reproduction order of the phrases based on the sentence information to reproduce and output voice data of the phrases in accordance with the reproduction order.

Additionally, the edition processing section 120 may receive edition input relating to waiting time information regarding the length of a soundless interval set in at least one of positions before and between the phrases included in the sentence, and the list information generation processing section 122 may generate sentence information including the waiting time information.

Based on the waiting time formation, the voice reproduction output processing section 140 may set a soundless interval before or between the phrases to reproduce and output voice of the voice data.

The voice reproduction command generating section 126 generates, based on the sentence information, a sentence voice reproduction command for providing an instruction for reading out voice data necessary to reproduce voice of the sentence from the voice data memory to reproduce the voice data in accordance with the reproduction order of the phrases included in the sentence.

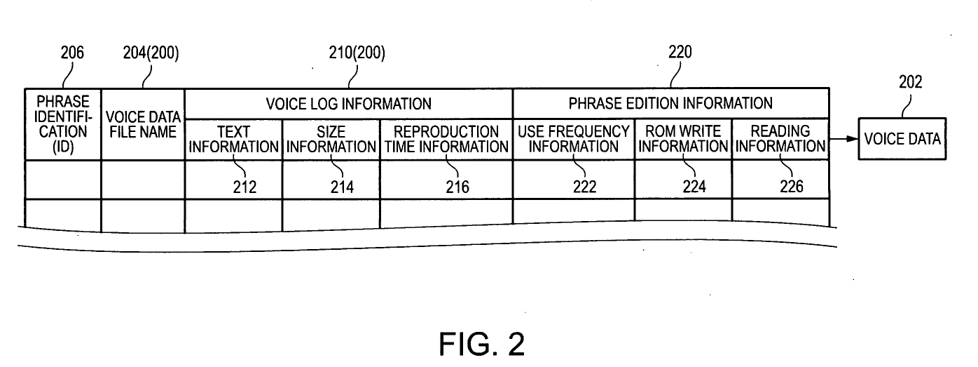

FIG. 2 is a diagram for illustrating voice data of a phrase and phrase information (an example of list information regarding the phrase).

Phrase voice data 202 is voice data per phrase generated by the phrase voice data generating section 130 using the TTS mode, based on the dictionary data stored in the dictionary data memory section 182. The voice data is a sound data file that can be reproduced by an existing voice reproduction system, and may be a compressed sound file.

Phrase information 200 may include a voice data file name 204 (phrase voice data file information) storing phrase voice data 202 and voice log information 210 corresponding to the phrase voice data 202 and may be stored so as to correspond to a phrase identification (ID) 206.

The voice log information 210 may include text information 212 as text data relating to how to read (pronounce) the phrases, or may include size information (such as a number of bytes) 214 of the file storing the phrase voice data. In addition, the voice log information 210 may include reproduction time information (ms) 216 of the phrase voice file, or may include other data (not shown) such as a text-to-voice (TTS) parameter or data-format data. The voice log information 210 may be generated concomitantly with generation of the phrase voice data 202.

Phrase edition information 220 is generated for each phrase based on a result of the edition processing of the embodiment to be maintained in association with the phrase ID 206. The phrase edition information 220 may include use frequency information 222 indicating how many times the phrase is used in a single sentence or a plurality of sentences. In addition, the phrase editing information 220 may include ROM write information 224 indicating a presence or absence of writing of the phrase in the ROM or may include reading information 226 phonetically indicating how to read (pronounce) the phrase. The reading information 226 may be generated or updated based on edition input information.

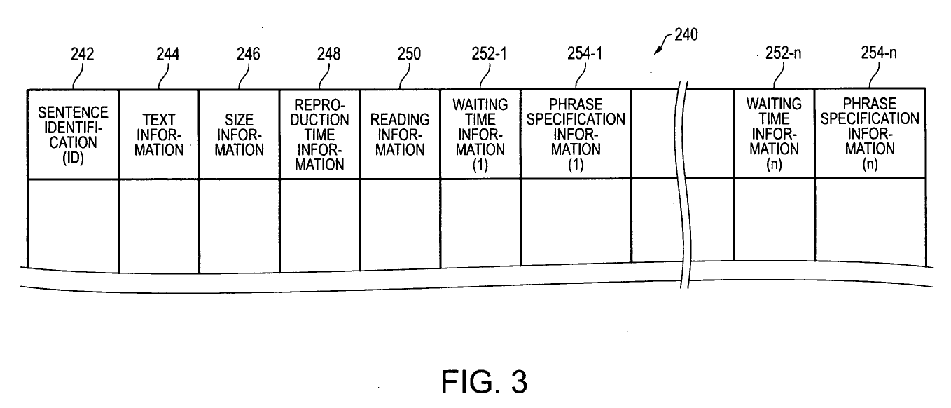

FIG. 3 is a diagram illustrating sentence information (an example of list information).

A sentence information 240 is generated based on the result of the editing processing and may be stored in association with a sentence ID 242.

The sentence information 240 may include text information 244 of phrases included in a sentence.

The sentence information 240 may include size data 246 of the sentence. The size data 246 of the sentence may represent a total number of bytes of voice data files of the phrases included in the sentence or a total number of bytes including soundless interval data, which is soundless voice data representing a waiting time.

The sentence information 240 may include sentence reproduction time information 248 that may represent a total of voice-file reproduction times of the phrases in the sentence or a total of the voice-file reproduction times thereof and waiting times set before, after, or between the phrases.

The sentence information 240 may include reading information 250 phonetically indicating how to read (pronounce) the sentence. Based on edition input information, the reading information 250 may be generated or updated.

The sentence information 240 may include phrase specification information (1) 254-1 to phrase specification information (n) 254-n included in the sentence. The phrase specification information (1) 254-1 to the phrase specification information (n) 254-n are data allowing access to file information of the voice data (202 shown in FIG. 2) corresponding to the phrases or may be the voice data file name (204 shown in FIG. 2) or the phrase ID (206 shown in FIG. 2). In addition, the phrase specification information (1) 254-1 to the phrase specification information (n) 254-n may be arranged in accordance with a reproduction order of the phrases (an index “n” coincides with the phrase reproduction order).

The sentence information 240 may include waiting time information (1) 252-1 to waiting time information (n) 252-n that are to be set before the phrases included in the sentence. The waiting time information (1) 252-1 to the waiting time information (n) 252-n may be arranged in accordance with a reproduction order of waiting times (an index n coincides with the phrase reproduction order).

Arranging the phrase specification information 254-1 to 254-n and the waiting time information 252-1 to 252-n in accordance with the reproduction order allows those data to be used as sequence information relating to the phrase reproduction order.

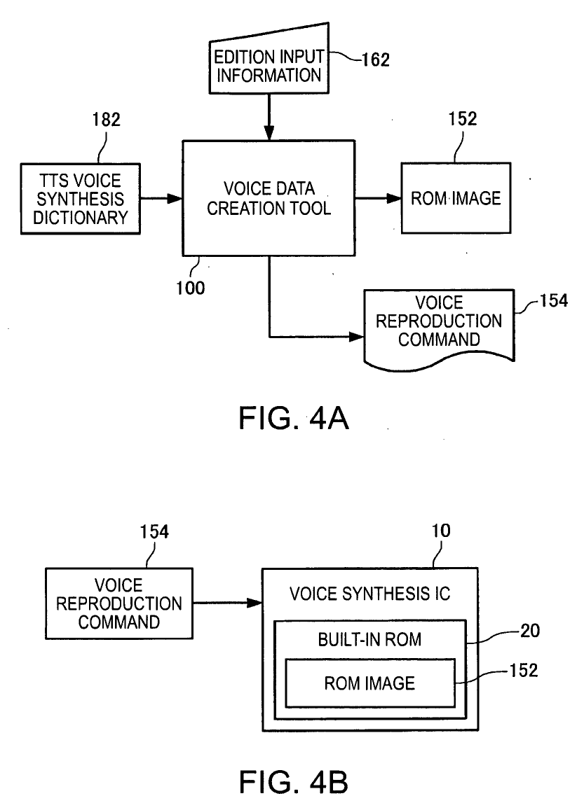

FIG. 4A illustrates a process for generating memory write information (a ROM image), and FIG. 4B shows a use form of the memory write information (the ROM image).

In FIG. 4A, reference numeral 100 denotes a voice data creation tool (a program or system) according to the embodiment, and reference numeral 10 denotes a voice synthesis IC having a voice function that outputs a message preset as a user interface incorporated in an electronic apparatus or the like. The voice synthesis IC 10 reproduces and outputs voice corresponding to a sentence based on a ROM image 152 stored in a built-in ROM 20 and the voice reproduction command 154.

In the present embodiment, using the voice data creation tool 100 allows generation of the ROM image (an aggregate of phrase voice data) 152 stored in the built-in ROM of the voice synthesis IC 10 and the voice reproduction command 154 based on edition input information 162.

For example, the voice data creation tool 100 can be operated as a voice data creation system by installing the voice data creation program of the embodiment in a personal computer (PC) or the like.

Using the voice data creation tool 100, a user can edit a voice guidance message (a sentence) that the user desires the voice synthesis IC 10 to speak. Then, the user can generate the ROM image 152 and the voice reproduction command 154. The ROM image 152 is an aggregate of phrase voice data files necessary to perform voice reproduction of the edited voice guidance message, and the voice reproduction command 154 is used to perform voice reproduction of the voice guidance message (the sentence) by reading the voice data file of the ROM image 152.

Upon an edition processing, the voice data creation tool 100 may display an edition screen as shown in FIG. 6 and FIGS. 8 to 10 in a display section of the PC to receive input of the edition input information 162 from a keyboard or the like of the PC. Then, based on edition input information 162 and the TTS voice synthesis dictionary (dictionary data) 182 stored in the information memory medium of the PC, the voice data creation tool 100 may generate voice data of phrases included in the sentence and list information. Thereafter, based on the voice data and the list information generated, the voice data creation tool 100 may generate and output the ROM image 152 (memory write information to be written in the voice data memory) and the voice reproduction command 154.

Text data of the sentence as the edition input information 162 may be input on the edition screen.

For example, the voice reproduction command 154 may be formed by arranging file specification information (such as file names) of the phrases in the sentence in a reproduction order.

The generated ROM image 152 may be stored in the built-in ROM of the voice synthesis IC 10 incorporated in an electronic apparatus or the like. The voice synthesis IC 10 includes the built-in ROM (a nonvolatile memory section) 20 storing the ROM image (the memory write information) 152 generated by the voice data creation tool 100. Then, the voice synthesis IC 10 serves as a voice reproducing section that receives the voice reproduction command 154 and reads voice data from the built-in ROM 20 based on the received voice reproduction command 154 to reproduce and output the voice guidance message corresponding to the desired sentence. In addition, the IC 10 may receive the voice reproduction command 154 from a host computer (such as a main controlling section in an electronic apparatus or the like).

In the present embodiment, based on the TTS voice synthesis dictionary (dictionary data) 182, voice data corresponding to phrases are generated using a text-to-voice (TTS) mode. The generated voice data may be maintained in a compressed format.

As the TTS mode, there are various modes such as a parametric mode, a concatenative mode, and a corpus-based mode. The embodiment can apply any of those modes. The parametric mode synthesizes sound by modeling a human speech process. The concatenative mode has phonemic piece data composed of voice data of a real person and synthesizes the phonemic piece data by combining the piece data and partially deforming connecting portions between the piece data according to need, for example. In the corpus-based mode, as a more evolved form, voice composition by a language-based analysis is performed to produce synthesized voices from real voice data. For example, the concatenative mode and the corpus-based mode may have a phoneme dictionary and a voice synthesizing section may generate synthesized voice data corresponding to a phonemic reading notation based on the phoneme dictionary.

The TTS voice synthesis dictionary (dictionary data) 182 includes a vocabulary dictionary and a phoneme dictionary, for example. The vocabulary dictionary may store data of a phonetic reading notation corresponding to a text notation, and the phoneme dictionary covers many phonemic data effective to improve voice quality. The vocabulary dictionary may be used to perform a front-end procedure in a text read-out processing and may store symbolic linguistic representations corresponding to the text notation (e.g. phonetic reading data corresponding to the text notation). In the front-end procedure, for example, numerals and abbreviations in a text may be converted into expressions to be read out, (which is referred to as normalization, preprocessing, or tokenization of the text); and each word may be converted into phonetic symbols and the text may be divided into prosodic units such as phrases, clauses, and sentences (where converting each word into phonetic symbols is referred to as text-to-phoneme (TTP) conversion or grapheme-to-phoneme (GTP) conversion). Then, the phonetic symbols and the prosodic data may be integrated together to be generated and output as the symbolic linguistic representations. In the text normalization, homonyms, numerals, abbreviations, and the like included in the text may be converted in such a manner that those words can be uttered.

The phoneme dictionary may receive the symbolic linguistic representations output after the front-end procedure to store waveform information of real sound (phonemes) corresponding to the symbolic linguistic representations. A major technology for generating a voice waveform in a back-end procedure includes concatenative synthesis and formant synthesis. The concatenative synthesis is basically a synthesizing method that connects recorded voice segments together.

In the embodiment, based on vocabulary data and sound data stored in the TTS voice synthesis dictionary (dictionary data) 182, such front-end and back-end procedures may be performed to generate voice data corresponding to text information of phrases included in a predetermined sentence.

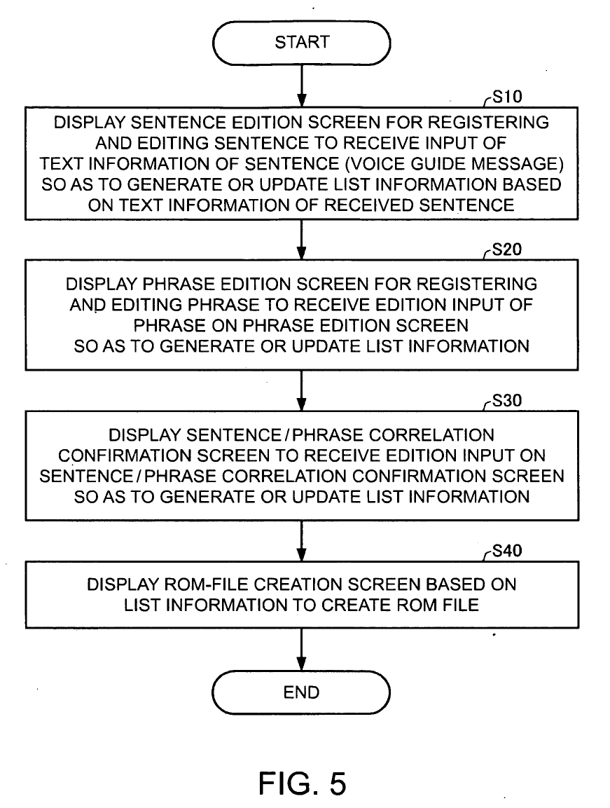

FIG. 5 is a flowchart showing a process from sentence edition to ROM-file creation.

When a sentence edition screen is selected to register and edit a sentence, input of text information of the sentence (a voice guidance message) is received to generate or update list information based on the text information received (Step S10).

FIG. 6 is a diagram showing an example of the sentence edition screen. A sentence edition screen 400 is used to add a sentence as a new entry or update a registered sentence. For example, as shown in FIG. 6, the sentence edition screen 400 may display information of a registered sentence (such as ID-412 and text information 414 of the sentence).

The user can input a sentence as an intended voice guidance message in text notation on a sentence column 410 of the sentence edition screen 400 to register the sentence, thereby generating list information based on information of the registered sentence. For example, the list information may include sentence information including phrase specification information of phrases included in the sentence and sequence information relating to a reproduction order of the phrases and information of the phrases included in the sentence. Alternatively, the list information may include information as shown in FIGS. 2 and 3.

FIG. 7 is a diagram showing an example of a sentence to be input. A sentence 430: “The time when it warms is 5 minutes.”, which is text data, includes a plurality of phrases consisting of 440-1, 440-2, and 440-3. In the present embodiment, the text data of the sentence 430 may also include pause data 420-1 and 420-2 indicating pauses between the phrases 440-1, 440-2, and 440-3. In this case, the pause data are represented by a forward slash mark “/”, but are not restricted to that and may be represented by any other form such as a character, a symbol, or a space, for example.

In this manner, based on the pause data 420-1, 420-2, and 420-3, the edition processing section 120 can perform the sentence dividing processing to divide the sentence 430 into the phrases 440-1 to 440-3.

When the user selects a phrase edition screen to register and edit phrases, the edition processing section 120 displays the phrase edition screen and receives edition input of the phrases on the phrase edition screen to generate or update list information (Step S20).

After sentence registration, sentence-related sentence information may be generated as list information.

Alternatively, after registering a sentence, sentence information and phrase information may be generated as list information. For example, the sentence information may include information shown in FIG. 3, and the phrase information may include information as shown in FIG. 2.

FIG. 8 is a diagram showing an example of a phrase edition screen. A phrase edition screen 500 is an edition screen for adding a phrase as a new entry or updating registered phrases. For example, as shown in FIG. 8, the phrase edition screen may display information of registered phrases (such as an ID 512, phrase text information 514, and phrase reading information 516).

On the sentence edition screen in FIG. 6, there are shown two sentences having respective sentence IDs: “s_0001” and “s_0002”. In this case, there may be registered sentence information of the two sentences: “The time when it warms is 5 min.” and “The time when it thaws is 5 min.” and phrase information relating to phrases: “The time”, “when it warms is”, “5 min”, “The time”, “when it thaws is”, and “5 min”. The phrases: “The time” and “5 min” are used in both sentences, and are each registered only one time as the phrase information. Accordingly, in the embodiment, any phrase used commonly in a plurality of sentences as above is registered only one time without being duplicately (separately) registered so as to allow the phrase to be shared in common in a plurality of sentences.

When the user selects a sentence/phrase correlation confirmation screen to confirm a predetermined sentence and phrases included in the sentence, the edition processing section 120 displays the sentence/phrase correlation confirmation screen to receive the user's edition input of the phrases on the sentence/phrase correlation confirmation screen so as to generate or update list information (Step S30).

After registering a sentence, there may be generated a list of phrases included in the sentence and a list of all phrases included in a plurality of sentences (where any phrase used commonly in multiple sentences and any phrase used a plurality of number of times in a single sentence are registered only once to avoid redundant registration of a same phrase).

FIG. 9 is a diagram showing an example of the sentence/phrase correlation confirmation screen. A sentence/phrase correlation confirmation screen 600 is an edition screen for performing confirmation and changing regarding a sentence, phrases included in the sentence, all phrases used commonly in multiple sentences.

For example, as shown in FIG. 9, a registered-sentence list 610 (an ID 612 and sentence text information 614) may be displayed. In addition, there may be displayed a phrase-for-use list 630 (a delay time 632, an ID 634, and phrase text information 636). The phrase-for-use list 630 may include information of phrases included in a sentence selected on the sentence list (for example, in a sentence where a cursor is positioned). The delay time 632 indicates a length of a soundless interval provided before each phrase upon reproduction of voice of the selected sentence. The length of the soundless interval before the each phrase may be, for example, set to a predetermined value as a default. In order to change the value, a value of a time per millisecond (ms) representing a length of a desired soundless interval may be input on each column of the delay time 632, and then, a delay-time change button 660 may be clicked.

Furthermore, there may be displayed an all-phrase list 650 (an ID 652 and phrase text information 654) indicating phrases used in a plurality of registered sentences.

Clicking a voice reproduction button 670 may allow reproduction of the voice of a sentence selected on the sentence list (such as a sentence where the cursor is positioned).

Based on the waiting time information of the sentence information (the delay time 632 in FIG. 9), the voice reproduction output processing section 140 may provide a soundless interval before or between the phrases included in the sentence to reproduce and output the voice of voice data of the phrases in the sentence. Thereby, the sentence can be uttered while reflecting the soundless interval before or between the phrases, so that the user can confirm sound on the spot.

In addition, voice data corresponding to the phrases, which are not yet generated, may be generated to be uttered. The voice data corresponding to the phrases may be generated when phrase information corresponding to a registered sentence is generated after sentence registration or when a ROM file is created.

When the user selects a ROM-file creation screen to create a ROM file storing voice data of all phrases included in sentences registered, the ROM-file creation screen is displayed based on list information to allow generation of the ROM file (Step S40).

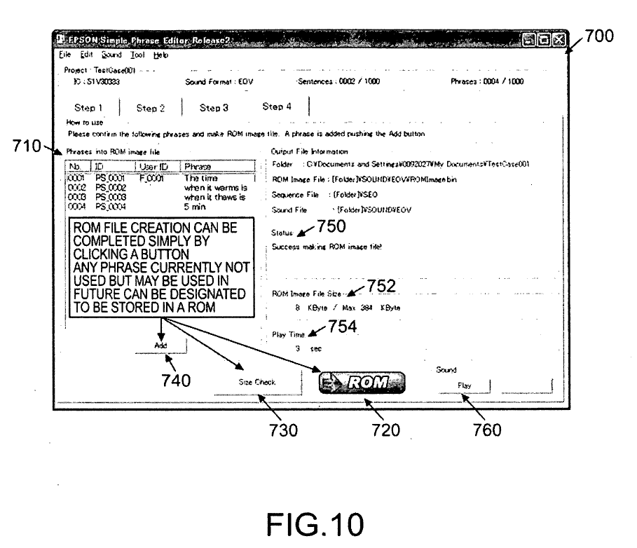

FIG. 10 shows an example of the ROM-file creation screen. For example, as shown in FIG. 10, a ROM file-storing phrase list 710 (an ID 712 and phrase text information 714) may be displayed. When the user clicks a ROM-file creation button 720, voice data (a ROM image) of phrases generated corresponding to all phrases of the ROM file-storing phrase list 710 are written in a designated memory medium (ROM) region. Clicking a size check button 730 may allow calculation and display of a size of the data written in the memory (ROM) (See 752). In addition, a reproduction time of a sentence corresponding to the data written in the memory (ROM) may be calculated and displayed (See 754).

The user may add or delete a phrase to be written in the ROM by referring to the data size 752 written in the memory (ROM) and the sentence reproduction time 754. Additionally, voice data corresponding to phrases not included in a sentence currently intended to be uttered may be generated for future use to be stored in the ROM. For example, clicking an addition button 740 may allow addition of a phrase.

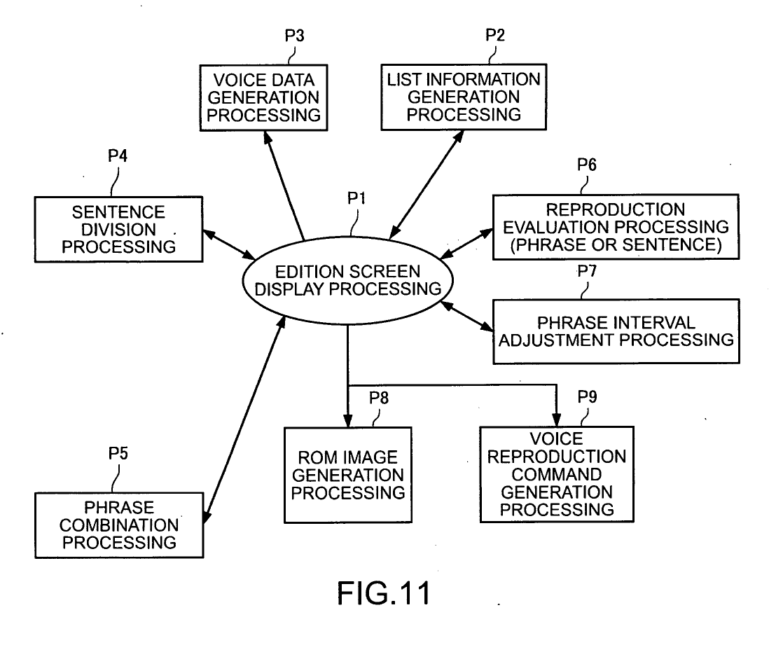

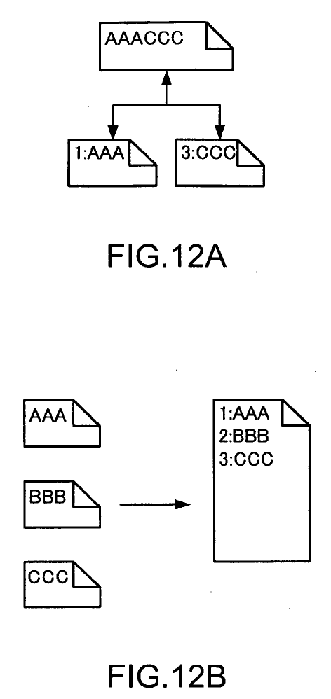

FIG. 11 and FIGS. 12A, 12B are diagrams illustrating processings performed by the voice data creation tool of the embodiment.

In the embodiment, each edition screen as shown in each of FIG. 6 and FIGS. 8 to 10 may be displayed to perform an edition screen display processing (P1) for receiving edition input information relating to phrases and sentences input on each edition screen.

In addition, in the embodiment, based on an edition result obtained by an edition input performed on the edition screen, a list information generation processing (P2) may be performed to generate list information such as phrase information and sentence information. The phrase information is an aggregate of data structured so as to allow data management per phrase. For example, as shown in FIG. 2, a phrase voice data file, reading data of voice, a reproduction time, a data size, a phrase-use count value, and the like may be stored in a manner corresponding to an ID or an index for specifying each phrase. Based on the phrase information, a phrase edition screen may be generated to be output to the display section.

For example, the sentence information is an aggregate of data structured so as to allow data management per sentence, as shown in FIG. 2. The sentence information may include text data, size information, reproduction time information, reading information of each sentence, phrases included in the sentence, and information of a waiting time provided before or between the phrases in a manner corresponding to an ID or an index for specifying the each sentence. Based on the sentence information, a sentence edition screen may be generated to be output to the display section.

Additionally, based on the edition input information received on the edition screen, a voice data generation processing (P3) may be performed to create and store voice data corresponding to the phrases. The voice data generated may be compressed per phrase to be stored as a voice file per phrase.

For example, the voice data may be created as a voice data file using an adaptive differential pulse code modulation (ADPCM) mode or an advanced voice coding-low complexity (AAC-LC) mode. When creating the voice data corresponding to the phrases, additional data such as reading information of the voice data and reproduction time information of phrase voice may be generated to be stored in association with the created voice data file.

Timing for generating the voice data corresponding to the phrases may be when generating the phrase information corresponding to the registered sentence after sentence registration, when creating the ROM file, or when providing an instruction for voice reproduction of the sentence and the phrases on the edition screen.

In the embodiment, a sentence division processing (P4) may be performed to receive input of a sentence text and divide the sentence into phrases.

For example, the sentence text input may be received on a sentence column of the sentence edition screen to be divided into phrases. For example, as described with reference to FIG. 7, the sentence division processing may be performed based on pause data indicating pauses between phrases included in text data of the sentence.

FIGS. 12A and 12B schematically show a successful example and an unsuccessful example in phrase information creation and the phrase division processing.

For example, as shown in FIG. 12A, a sentence “AAACCC” is input and then, the sentence division processing is performed to divide the input sentence into two phrases: “AAA” and “CCC”. The sentence division processing may be performed by a syntactic analysis of the sentence, based on phrase pause data, or the like.

When there is not as yet any registration of phrase information relating to the phrases “AAA” and “CCC” extracted by the sentence division processing, phrase information relating to the extracted phrases “AAA” and “CCC” (an example of list information), as shown in FIG. 12B is registered.

Whether the extracted phrases are present or not in the phrase information may be determined by comparatively checking text data of the extracted phrases and text data corresponding to the registered phrases.

A sentence division result may be displayed on the sentence/phrase correlation confirmation screen as shown in FIG. 9.

In the embodiment, a phrase combination processing (P5) may be performed to generate a sentence based on designated phrases. For example, when the phrase “AAA” and a phrase “BBB” are selected in this order, those phrases may be combined to generate a sentence of “AAABBB”.

In the embodiment, additionally, a reproduction evaluation processing (P6) may be performed to evaluate voice reproduction of the generated sentence and the phrases. In the sentence reproduction evaluation processing (P6), based on specification information of the phrases included in the sentence, voice data corresponding to the phrases of the sentence my be read out from the memory section to reproduce and output voice of the read-out voice data in accordance with sequence information of the sentence information. Furthermore, based on waiting time information of the sentence information, a soundless interval may be set before or between the phrases to reproduce and output voice of the voice data. The voice reproduction of the sentence may be performed by clicking a voice reproduction button 460 on the sentence edition screen (FIG. 6) or a voice reproduction button 670 on the sentence/phrase correlation confirmation screen (FIG. 8).

The voice reproduction of the phrases may be performed by clicking a voice reproduction button 530 on the phrase edition screen (FIG. 8) or a voice data confirmation button 7G0 of the ROM creation screen (FIG. 10).

In addition, in the embodiment, a phrase interval adjustment processing (P7) may be performed to adjust a phrase interval by setting a delay time before or between the phrases included in the sentence. As the phrase interval adjustment processing (P7), for example, regarding the length of a soundless interval set in at least one of positions before and between the phrases included in the sentence, edition input relating to waiting time information may be received to generate sentence information that includes the waiting time information.

Furthermore, in the embodiment, a ROM image generation processing (P8) may be performed to generate a ROM image (contents of data to be stored in the ROM) when storing voice data necessary for utterance of a generated sentence in the memory. In the ROM image generation processing (P8), a phrase intended to be stored in the voice data memory may be extracted based on phrase information; then, voice data of the extracted phrase may be read out from the memory section; and memory write information (a ROM image) to be written in the voice data memory may be generated to be written in the memory (ROM) as a target storage section. In this manner, the memory write information (the ROM image) can be generated such that voice data of same phrases included in a plurality of sentences are not duplicately stored in the memory.

Still furthermore, in the embodiment, a voice reproduction command generation processing (P9) may be performed to generate a voice reproduction command for designating voice data read out from the ROM image and a reproduction order of the voice data to synthesize sentence voice. In the voice reproduction command generation processing (P9), the voice reproduction command may be generated to provide an instruction for reproducing and outputting voice data corresponding to phrases included in a sentence by reading out the voice data in accordance with sequence information stored in the voice data memory, based on phrase specification information of sentence information.

It is obvious that the above embodiment is just an example and various modifications are possible within the scope of the invention.

Embodiments of the invention may include substantially the same arrangements as those described in the above embodiment (for example, the same functions, manners, and results, or the same advantages and advantageous effects as those in the above embodiment). In addition, embodiments of the invention may include arrangements provided by changing non-essential parts in the arrangements described in the above embodiment. Furthermore, embodiments of the invention may include arrangements capable of providing the same operational effects as those described in the above embodiment or achieving the same advantages as those in the embodiment. Still furthermore, embodiments of the invention may include arrangements provided by adding at least one well-known technique to the arrangements described in the above embodiment.

What is claimed is:

1. A voice data creation system, comprising:
a dictionary data memory section that stores dictionary data for generating synthesized voice data corresponding to text data;
an edition processing section that displays an edition screen for editing a voice guidance message as a sentence including a plurality of phrases to receive edition input formation so as to perform an edition processing based on the edition input information;
a list information generation processing section that generates list information relating to each sentence and phrases included in the each sentence based on a result of the edition processing;
a phrase voice data generating section that determines a target phrase for voice data creation based on the list information to generate and maintain voice data corresponding to the target phrase determined for voice data creation based on the dictionary data; and
a memory write information generating section that determines a target phrase to be stored in a voice data memory based on the list information to generate memory write information including voice data of the target phrase determined to be stored in the memory,
wherein the edition processing section divides a sentence input on the edition screen into a plurality of phrases based on text data of the sentence input; the list information generation processing section specifies the phrases included in the sentence and a reproduction order of the phrases based on a result of the sentence division to generate sentence information including phrase specification information of the phrases included in the sentence and sequence information relating to the reproduction order of the phrases; the phrase voice data generating section generates synthesized voice data corresponding to text data of the target phrase for voice data creation based on the dictionary data; and the memory write information generating section determines the target phrase to be stored in the memory such that voice data of a phrase used commonly in a plurality of sentences and a phrase used a plurality of number of times in a single sentence are not duplicately stored.

2. The voice data creation system according to claim 1, wherein the text data of the sentence includes pause data indicating a phrase pause, and the edition processing section performs the sentence dividing processing based on the pause data.

3. The voice data creation system according to claim 1, wherein the memory write information generating section calculates a total size of the memory write information to output size information based on a result of the calculation.

4. The voice data creation system according to claim 1, wherein the edition processing section performs a display output processing for displaying the phrases included in the sentence.

5. The voice data creation system according to claim 1, wherein the edition processing section combines a plurality of phrases to create each sentence based on the edition input information, and the list information generation processing section specifies the phrases included in the each sentence and a reproduction order of the phrases based on a result of the phrase combination to generate sentence information including phrase specification information of the phrases included in the sentence and sequence information relating to the reproduction order of the phrases.

6. The voice data creation system according to claim 1, wherein the edition processing section generates and maintains reading information indicating a way to read (pronounce) the sentence or the phrases to display and output the reading (pronunciation) of the sentence or the phrases based on the maintained reading information.

7. The voice data creation system according to claim 6, wherein the edition processing section receives reading input information relating to the reading information of the sentence or the phrases to update the maintained reading information based on the received reading input information.

8. The voice data creation system according to claim 1 further including a voice reproduction output processing section that determines the phrases included in the sentence and the reproduction order of the phrases based on the sentence information to reproduce and output voice data of the phrases in accordance with the reproduction order.

9. The voice data creation system according to claim 1, wherein the edition processing section receives edition input of waiting time information regarding a length of a soundless interval set in at least one of positions before and between the phrases included in the sentence, and the list information generation processing section generates the sentence information that further includes the waiting time information.

10. The voice data creation system according to claim 9, wherein the voice reproduction output processing section sets the soundless interval before or between the phrases based on the waiting time information to reproduce and output voice of the voice data.

11. The voice data creation system according to claim 1 further including a voice reproduction command generating section that generates a sentence voice reproduction command, the command providing an instruction for reading out voice data necessary to reproduce voice of the sentence from the voice data memory to reproduce the voice data in accordance with the reproduction order of the phrases included in the sentence based on the sentence information.

12. A program allowing a computer to operate as a voice data creation system, the system comprising:
a dictionary data memory section that stores dictionary data for generating synthesized voice data corresponding to text data;
an edition processing section that displays an edition screen for editing a voice guidance message as a sentence including a plurality of phrases to receive edition input formation so as to perform an edition processing based on the edition input information;
a list information generation processing section that generates list information relating to each sentence and phrases included in the each sentence based on a result of the edition processing;
a phrase voice data generating section that determines a target phrase for voice data creation based on the list information to generate and maintain voice data corresponding to the target phrase determined for voice data creation based on the dictionary data; and
a memory write information generating section that determines a target phrase to be stored in a voice data memory based on the list information to generate memory write information including voice data of the target phrase determined to be stored in the memory,
wherein the edition processing section divides a sentence input on the edition screen into a plurality of phrases based on text data of the sentence input; the list information generation processing section specifies the phrases included in the sentence and a reproduction order of the phrases based on a result of the sentence division to generate sentence information including phrase specification information of the phrases included in the sentence and sequence information relating to the reproduction order of the phrases; the phrase voice data generating section generates synthesized voice data corresponding to text data of the target phrase for voice data creation based on the dictionary data; and the memory write information generating section determines the target phrase to be stored in the memory such that voice data of a phrase used commonly in a plurality of sentences and a phrase used a plurality of number of times in a single sentence are not duplicately stored.

13. A method for producing a voice synthesis semiconductor integrated circuit device including a nonvolatile memory section, the method comprising:
preparing a dictionary data memory section that stores dictionary data for generating synthesized voice data corresponding to text data;
displaying an edition screen for editing a voice guidance message as a sentence including a plurality of phrases to receive edition input information to perform an edition processing based on the edition input information;
generating list information relating to each sentence and phrases included in the each sentence based on a result of the edition processing;
determining a target phrase for voice data creation based on the list information to generate and maintain voice data corresponding to the target phrase determined for voice data creation based on the dictionary data; and
determining a target phrase to be stored in the nonvolatile memory section based on the list information to generate memory write information including voice data of the target phrase determined to be stored in the memory, wherein the edition processing divides a sentence input on the edition screen into a plurality of phrases based on text data of the sentence input; the list information generation processing specifies the phrases included in the sentence and a reproduction order of the phrases based on a result of the sentence division to generate sentence information including phrase specification information of the phrases included in the sentence and sequence information relating to the reproduction order of the phrases; the phrase voice data generation processing generates synthesized voice data corresponding to text data of the target phrase for voice data creation based on the dictionary data; and the memory write information generation processing determines the target phrase to be stored in the memory such that voice data of a phrase used commonly in a plurality of sentences or a phrase used a plurality of number of times in a single sentence are not duplicately stored.

14. A semiconductor integrated circuit device including a nonvolatile memory section storing the memory write information generated by the voice data creation system according to claim 1 and a voice synthesizing section receiving a voice reproduction command to read out the voice data included in the memory write information from the nonvolatile memory section so as to reproduce and output the voice data based on the received voice reproduction command.
